(19) United States
(12) Patent Application Publication
(10) Pub. No.: US 2008/0247722 A1
(43) Pub. Date: Oct. 9, 2008

(54) Waveguide and Lighting Device

(75) Inventors: Ramon Pascal Van Gorkom, Eindhoven (NL); Marcellinus Petrus Carolus Michael Krijn, Eindhoven (NL); Anthonie Hendrik Bergman, Eindhoven (NL); Michel Cornelis Josephus Marie Vissenberg, Eindhoven (NL); Willem Lubertus Ijzerman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,333

(22) PCT Filed: Sep. 12, 2006
(86) PCT No.: PCT/IB2006/053232

§ 371 Date: Mar. 19, 2008

(30) Foreign Application Priority Data
Sep. 19, 2005 (EP) 05108581.9

(51) Int. Cl. G02B 6/10

(52) U.S. Cl. 385/129

(57) ABSTRACT

A waveguide (40; 51; 61), arranged to guide light from at least one light source (53a-c), the waveguide comprising at least one guiding edge (43; 50a-c; 60) adapted to contain the light in the waveguide (40; 51; 61), and an extraction edge (44; 50d) adapted to enable extraction of the light from the waveguide (40; 51; 61), wherein the guiding edge (43; 50a-c; 60) is configured to reflect the light on its way towards the extraction edge (44; 50d). The guiding edge (43; 50a-c; 60) is further configured such that a direction (xr1, Xr2) of reflection of a ray of light impinging on the guiding edge (43; 50a-c; 60), in a given direction (xi) of incidence relative to a general direction (X0) of extension of the guiding edge (43; 50a-c; 60), is dependent on a position (P1, P2) of incidence along the guiding edge (43; 50a-c; 60). The waveguide may be configured such that virtually no light is lost through back-scattering or unintentional extraction or outcoupling through the at least one guiding edge.

The present invention relates to a waveguide, arranged to guide light from at least one light source, the waveguide comprising at least one guiding edge adapted to contain the light in the waveguide, and an extraction edge adapted to enable extraction of the light from the waveguide, wherein the guiding edge is configured to reflect the light on its way towards the extraction edge.

The invention further relates to a lighting device comprising such a waveguide and a display device including such a lighting device.

There are several lighting applications in which light from at least one light source is coupled into a waveguide and emitted from one or several surfaces of the waveguide. In some applications, for example a backlight for a liquid-crystal display, light can be coupled out through a top surface of a large size planar waveguide. In other applications, light can be coupled out at one or several edges of the waveguide. By using a planar waveguide and coupling light out at at least one of its edges, several different types of lighting devices can be realized. One example of such a lighting device is a transparent lamp, which is formed by a number of planar waveguides. In the case of such a lamp, light can be extracted from selected portions of the lamp surface by forming the emitting edges of the waveguides as angled mirrors at the proper locations.

Suitable light sources for such lighting devices include light emitting diodes (LEDs). LEDs are generally narrow banded, and some processing of light emitted from a LED is typically required to produce white light. An energy efficient way of producing white light is to combine light emitted by light sources, such as LEDs, of suitable colors (typically red, green and blue) to form white light.

Such a combination of light from differently colored LEDs may take place in the waveguide and the intensity and spatial color distribution of mixed light emitted from the waveguide is generally rather uniform at the extraction edge(s) of the waveguide. Some distance away from this/these edge(s), however, variations in intensity and/or color are perceivable. Since the human eye is very sensitive to slight variations in color, a very good color mixing is required to produce uniform white light.

Also in the case of white or colored light emitted by a single light source and guided through a waveguide, insufficient spatial uniformity may be experienced, especially at some distance away from the extraction edge(s) of the waveguide.

One known method of improving spatial uniformity of light extracted from a waveguide is to diffuse the outcoupling edge of the waveguide. Through this method, an improved spatial uniformity may be achieved. However, the energy efficiency is decreased through back-scattering of light and the extracted light may diverge more than is desirable.

There is thus a need for a more energy-efficient way of reducing spatial intensity and/or color variations perceived at some distance from the extraction edge(s) of a waveguide.

In view of the above-mentioned and other drawbacks of the prior art, an object of the present invention is to provide a more energy-efficient way of improving spatial uniformity of light emitted by a waveguide.

According to a first aspect of the present invention, these and other objects are achieved through a waveguide, arranged to guide light from at least one light source, the waveguide comprising at least one guiding edge adapted to contain the light in the waveguide, and an extraction edge adapted to enable extraction of the light from the waveguide, wherein the guiding edge is configured to reflect the light on its way towards the extraction edge, wherein the guiding edge is further configured such that a direction of reflection of a ray of light impinging on the guiding edge in a given direction of incidence, relative to a general direction of extension of the guiding edge, is dependent on a position of incidence along the guiding edge.

The waveguide may be made of a slab of a single dielectric material or combinations of dielectric materials. Suitable dielectric materials include different transparent materials, such as various types of glass, poly-methyl methacrylate (PMMA) etc. The waveguide may also be air, at least partly enclosed by waveguide reflectors. A waveguide comprising a slab of a dielectric material may for its function rely upon total internal reflection (TIR), reflectors or a combination of TIR and reflectors at the edges and/or top and/or bottom surfaces.

By “spatial uniformity” of light should here be understood uniformity of light in the space domain. Spatial uniformity includes uniformity in color and intensity. In fact, variations in color in a “white light” application may be equivalent to intensity variations in a monochrome application.

That the extraction edge is adapted to enable extraction of the light from the waveguide means that the extraction edge is directly involved in coupling the light out of the waveguide. The extraction or outcoupling could take place directly through the extraction edge or, following a final reflection in the extraction edge, through the top and/or bottom surface of the waveguide in the direct vicinity of the extraction edge. The extraction edge may be configured in various ways—it may be flat, curved, prism-shaped, rounded, more or less diffuse etc.

The present invention is based upon the realization that the main mechanism behind the non-uniformity of light extracted from a conventional waveguide is insufficient mixing of light coming directly from the at least one light-source and light reflected in the edges of the waveguide. An effect of this is that the number of light-sources (real and virtual) that are visible for a viewer through the waveguide depends on the position of observation. This leads to variations in intensity and/or color depending on position of observation. A solution to the problem would be to drastically increase the number (or actually the density) of light-sources. Thereby the relative number of visible light-sources (real and virtual) would only vary slowly and continuously with position of observation.

By configuring the at least one guiding edge of the waveguide such that the direction of reflection of a ray of light impinging on the guiding edge, in a given direction of incidence, relative to a general direction of extension of the guiding edge, is dependent on a position of incidence along the guiding edge, the number of perceived virtual light-sources is increased and an improved mixing of extracted light achieved.

An effect obtained through the present invention is the waveguide may be configured such that virtually no light is lost through back-scattering or unintentional extraction or outcoupling through the at least one guiding edge. Furthermore, the at least one guiding edge may be configured for a minimal increase in beam divergence compared to a conventional waveguide.

According to one embodiment of the present invention, the at least one guiding edge may exhibit a macro-structure along its general direction of extension.

By “macro-structure” should be understood a structure having dimensions that are much (typically 100-10000 times) larger than the wavelength of the guided light.

Through the provision of a macro-structure on the guiding edge of the waveguide, varying directions of reflection for light rays incident in a given direction may be obtained along the guiding edge. Thereby, the spatial uniformity of light extracted from the extraction edge of the waveguide is improved.

The macro-structure may comprise at least one curved portion.

The direction of reflection of a ray of light incident in a given direction of incidence on a curved reflective surface depends on the position of incidence along the curved portion. Consequently, a larger number of directions of reflection are obtained for a particular light source or, in other words, a larger number of virtual light sources are obtained. From this follows a better mixing of light from different light-sources and improved uniformity of extracted light.

Advantageously, rounded comers of the waveguide may constitute these curved portions.

The macro-structure may further comprise a plurality of curved portions.

For example, the entire guiding edge(s) of the waveguide may be made up of curved portions with centers of curvature on alternating sides of the guiding edge in a plane essentially parallel to the top and/or bottom surface of the waveguide. Thereby, an even larger number of directions of reflection can be obtained and consequently improved mixing of light and improved spatial uniformity of extracted light.

Advantageously, these curved portions may, along at least a portion of the guiding edge(s), be formed essentially periodically with a period being smaller than or having a same order of magnitude as a spacing between the light sources. Thereby, a further improved mixing of light may be achieved.

For a sufficient degree of mixing to occur, at least one of said curved portions should preferably span an angular distance greater than 1 degree.

This spanned angular distance should, however, not be too large since that may lead to increased back-reflection and, in the case of total internal reflection (TIR), outcoupling through the guiding edge(s).

Advantageously, at least one of said curved portions should span an angular distance greater than 1 degree and smaller than 10 degrees.

When reflection in the guiding edge relies on TIR, light incident at an angle smaller than a critical angle with respect to the normal of the reflecting surface will escape the waveguide. In order to minimize the amount of light lost through the guiding edge several options exist. These include combining TIR and reflectors, and applying a metallic or reflective multi-layer coating to the guiding edge(s).

TIR and reflectors can be combined in a number of ways. For example, a reflector can be arranged distanced from a slab waveguide guiding edge(s) and to follow the macrostructure of this/(these) edge(s). The gap between the reflector and this edge may be filled with air or any other material having a lower refractive index than the slab material. Thereby, light incident at large angles are reflected by TIR and light incident at small angles are reflected by the reflector. This results in a low absorption of light.

The macro-structure may further be essentially saw-tooth shaped, having positive and negative peaks. Preferably at least one of these peaks may have an opening angle greater than 160 degrees.

Analogously to what is described above in connection with curved portions, the essentially saw-tooth shaped macro-structure may be periodical along at least a portion of the guiding edge(s) and then preferably with a period corresponding to or smaller than the spacing between the light sources.

According to another embodiment of the present invention, the at least one guiding edge may be configured to provide diffuse reflection.

By “diffuse” should here be understood that irregularities in the reflecting surface are large compared to the wavelength of the reflected light, while the surface is still macroscopically flat.

By making the surface of the guiding edge diffuse, light incident in a given direction will reflect differently depending to the position of incidence. Of course, the diffuse guiding edge may be essentially straight or exhibit a macrostructure.

Preferably, the guiding edge is configured to provide asymmetrically diffuse reflection, whereby the amount of back-scattering can be reduced and a larger portion of the light reflected towards the extraction edge.

In order to minimize unwanted outcoupling of light through a diffusely reflecting guiding edge, a diffuse mirror can be formed, for example by applying a metallic coating to a diffusing guiding edge surface.

According to a further embodiment of the present invention, the at least one guiding edge may be provided with a sub-wavelength structure capable of modifying the direction of reflection.

By forming certain sub-wavelength structures (structures typically having dimensions smaller than wavelengths of the reflected light) such as gratings or holographic structures, the direction of reflection of light can be modified.

Preferably, the waveguide may be a planar waveguide.

A “planar waveguide” is here defined as a waveguide having an essentially rectangular cross-section and being bounded by top and bottom surfaces and edges, the top and bottom surfaces having substantially larger extensions than the edges.

Furthermore, the waveguide may be arranged to guide light from a plurality of light sources.

According to a second aspect of the invention, these and other objects are achieved by a lighting device comprising at least one light source and a waveguide according to the present invention.

Advantageously, this at least one light source may be at least one of side-emitting and lambertian LEDs.

According to a third aspect of the invention, these and other objects are achieved by a display device comprising a display and a lighting device according to the present invention.

These and other aspects of the present invention will now be described in more detail, with reference to the appended drawings showing a currently preferred embodiment of the invention, wherein:

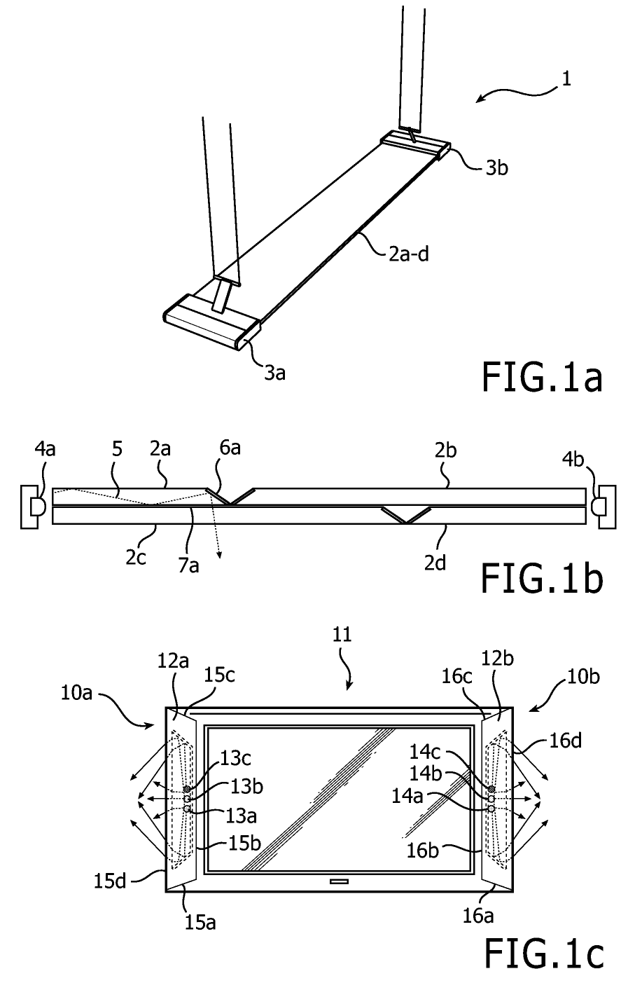

FIGS. 1a-b schematically show a first example of an application for a waveguide according to the present invention.

FIG. 1c schematically shows a second example of an application for the waveguide according to the present invention.

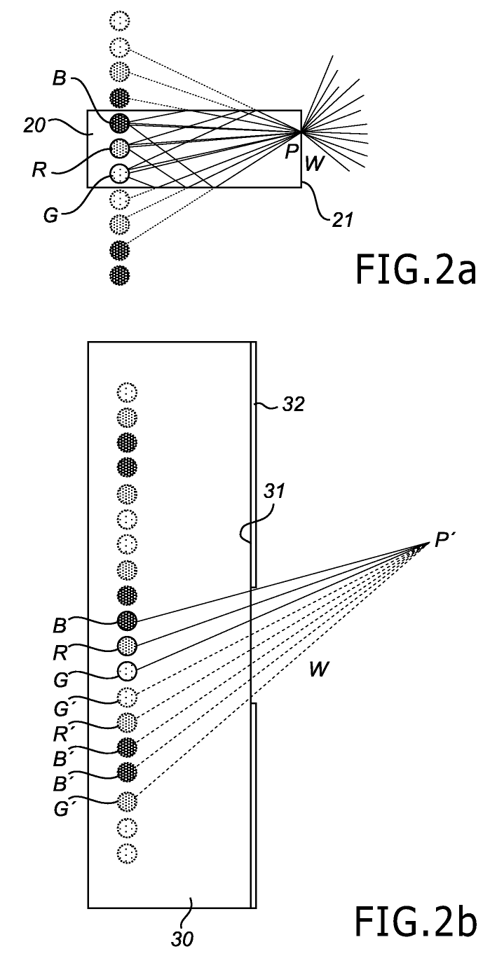

FIGS. 2a-b schematically show a mechanism behind color variations and/or intensity variations in conventional waveguides.

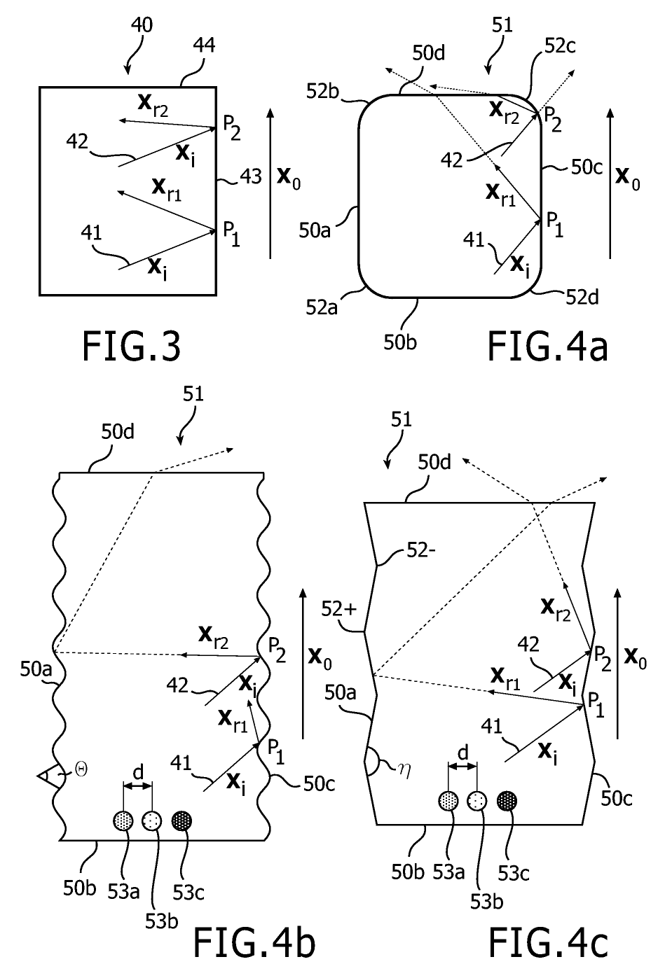

FIG. 3 schematically shows a top view of a waveguide according to the present invention.

FIG. 4a-c schematically show examples of waveguide according to a first embodiment of the present invention, exhibiting macro-structure.

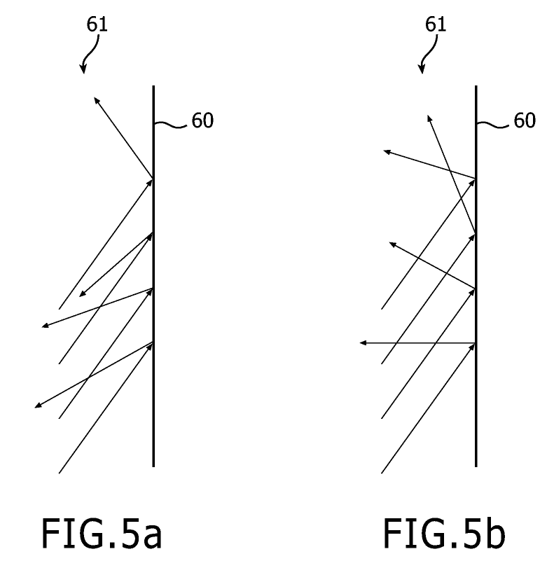

FIGS. 5a-b schematically show a waveguide according to a second embodiment of the present invention, having diffuse edges.

In FIGS. 1a-b, a first example of an application for a waveguide according to the invention is shown.

FIG. 1a illustrates, in a perspective view, a lighting device 1 in the form of a flat transparent lamp mainly constituted by a number of planar transparent waveguides 2a-d suspended between two holders 3a-b. In the holders, 1-D arrays of light-sources 4a-b, here in the form of lambertian LEDs (not visible in FIG. 1a, see FIG. 1b), are contained.

In FIG. 1b, it is illustrated, using a single ray 5 of light, how light from one of the light-source arrays 4a is coupled into one 2a of the waveguides, transported by the waveguide and, after reflection in a mirror formed at an extraction edge 6a, coupled out of the waveguide 2a through the bottom surface 7a of the waveguide 2a in the vicinity of the extraction edge 6a. Light is, of course, guided through the remaining waveguides 2b-d in the same fashion. In the above example, four waveguides 2a-d are used. Of course, a larger number of waveguides could be used.

In FIG. 1c, a second example of an application for a waveguide according to the invention is schematically shown. Here, two lighting devices 10a-b are integrated in a display device 11, here in the form of a flat TV-set. The purpose of the lighting devices 10a-b is to provide ambient lighting around the TV-set to thereby improve the viewing experience of a user. Each of the lighting devices 10a-b includes a waveguide 12a-b and three side-emitting LEDs 13a-c; 14a-c which are preferably red (R) green (G) and blue (B). Each of the waveguides further has three guiding edges 15a-c; 16a-c and one transmissive, extraction edge 15d; 16d.

During operation of these ambient lighting devices 10a-b, light from the colored light-sources 13a-c, 14a-c is transported and mixed in the waveguides 12a-b to be emitted as white light through the extraction edges 15d, 16d.

If conventional waveguides were used in the above-described lighting devices 1; 10a-b, the emitted light would typically not be perceived as uniformly white, but rather as exhibiting, potentially strong, color and/or intensity variation. A strongly contributing reason for these variations will be explained below with reference to FIGS. 2a-b.

In FIG. 2a, a conventional waveguide 20 with three embedded light-sources R, G, B is schematically shown. At a point P at the extracting edge 21 of the waveguide 20, all the light-sources R, G, B as well as their reflections in the reflecting side edges 22a-b of the waveguide 20 can be seen. Hence, the emitted light is perceived as white at the point P. Moving away from the extraction edge 21 of the waveguide 20, this is, however, not the case in all locations. The reason for this is best illustrated in FIG. 2b.

FIG. 2b shows an alternative way of illustrating the fact that the visible number of light-sources R, G, B and reflections thereof R′, G′, B′ is different depending on position of observation and that this effect has an influence on the color and/or intensity of the emitted light. Here, the waveguide 20 in FIG. 2a with light-sources R, G, B and reflections thereof is substituted by an infinitely long waveguide 30 with an infinite number of light-sources R, G, G, R′, G′, B′. Covering the outcoupling edge 31 of this waveguide 30 is a mask 32, having an opening with the same width W as the waveguide 20 in FIG. 2a. At a given point P′, 8 light sources R, G, B, B′, G′ R′, B′, G′ are visible. Hence, the light at this point P′ is a mixture of light from two red, three green and three blue light-sources. The light is thus not perceived as white but rather as a light cyan. Other viewing positions yield other perceived colors and/or intensities.

In FIG. 3, a waveguide 40 according to the present invention is schematically shown in a top view. Here, two light rays 41, 42 are shown to impinge on a guiding edge 43 of the waveguide 40 in the same direction of incidence xi, relative to the general direction of extension of the guiding edge x₀, at positions P₁ and P₂, respectively. As apparent from the figure, the directions of reflection xᵣ₁, xᵣ₂ of the two rays 41, 42 are different from each other. Following a number of reflections, the light rays 41, 42 are extracted through the extraction edge 44.

FIGS. 4a-c schematically show three examples of a first embodiment of the present invention, according to which at least one of the guiding edges 50a-c of the waveguide 51 exhibits a macrostructure. The extraction edge 50d is shown flat and smooth, but could possess other properties as well, such as, for example, being diffuse, rounded or prism-shaped.

In FIG. 4a, a waveguide 51 having rounded corners 52a-d is shown. As in FIG. 3, two incident rays of light 41, 42 are shown to impinge on a guiding edge 50c of the waveguide 51 in the same direction of incidence xᵢ, relative to the general direction of extension of the guiding edge x₀, at positions P₁ and P₂, respectively, and once again the directions of reflection xᵣ₁, xᵣ₂ of the two rays 41, 42 are different from each other. It should be noted that the corners 52b,c closest to the extraction edge 50d are also part of the outcoupling structure of the waveguide 51. The ray of light 42 impinging on the curved portion formed by the rounded corner 52c will not only be reflected, but also partly outcoupled and leave the waveguide, as indicated in FIG. 4a.

In FIG. 4b, a second example of the first embodiment of the waveguide according to the invention is schematically shown. Here, two of the guiding edges 50a,c are shown having an undulating or corrugated appearance. Through this arrangement, a larger number of directions of reflections is obtained, as compared to the first example described above.

FIG. 4c schematically shows yet another possible implementation of the macrostructure of the first embodiment of the waveguide according to the present invention. Here, the guiding edges 50a, c are corrugated in a shallow saw-tooth shaped manner, having positive and negative peaks. One pair of such peaks are indicated by reference numerals 52+ and 52−, respectively.

In the second and third examples above, entire guiding edges 50a, c are shown having corrugated shapes. Of course, embodiments according to which only parts of guiding edges exhibit such corrugated shapes are also within the scope of the present invention.

Advantageously, the shapes of the macro-structured guiding edges are formed such that a minimal amount of back-reflection and outcoupling through the guiding edges (in the case of the waveguide relying on total internal reflection) while sufficient light mixing is achieved. For the macrostructure according to the second example above, this is done by forming the curved portions such that at least one of the curved portions spans an angular distance θ which is greater than 1° and smaller than 10°. Generally, a smaller angular distance θ is required in the vicinity of light sources 53a-c than further away from the light sources 53a-c. Furthermore, the angular distance θ should be smaller the longer the waveguide is.

Regarding the essentially saw-tooth shaped macrostructure of the third example above, an opening angle of at least one of the peaks 52+,− has an opening angle η which is greater than 160°.

In order to achieve optimal light mixing, a period of the macrostructures described above should preferably be in the same range as or smaller than a spacing distance d between the light sources 53a-c.

In FIGS. 5a-b two examples of a second embodiment of a waveguide according to the present invention are schematically shown.

FIG. 5a schematically shows a first example of a guiding edge 60 of a waveguide 61 (only partly shown). On a macroscopic scale, the surface of the edge 60 appears flat. It has, however, been roughened in order to produce partly diffuse reflections. In FIG. 5a, symmetric diffusion is illustrated. This means that incident light is substantially uniformly reflected in all possible directions. Hereby, a very large number of directions of reflection are obtained. However, a portion of the incident light is lost due to back-reflection and (in the case of a TIR-type waveguide) outcoupling through the guiding edge 60.

Some outcoupling through the guiding edge can be tolerated. This outcoupling can, however, be avoided by, for example, adding a reflector directly on the guiding edge or adding a reflector distanced from and parallel with the guiding edge and filling the gap thus formed with air or any other material having a low refractive index. In the latter case, the absorption is minimized while avoiding outcoupling through the guiding edge.

In FIG. 5b, the guiding edge 60 is instead asymmetrically diffusing. A diffusing surface can be asymmetrically diffusing to different degrees. For example, the guiding edge 60 may, as illustrated in FIG. 5b, reflect light in all forward directions and not backwards.

The person skilled in the art realises that the present invention by no means is limited to the preferred embodiments described above. On the contrary, many modifications and variations are possible within the scope of the appended claims. For example, combinations of macrostructure and diffuse surfaces may advantageously be used for achieving improved spatial uniformity of emitted light. Furthermore, a larger number and other colors of light-sources than those described above may be used. Especially for general purpose lighting applications, it may be useful to add a fourth or even a fifth color, such as amber or cyan, which improves the color rendering index. In addition to the guiding edges, the top and bottom surfaces of the waveguide can also be configured such that the direction of reflection varies with position of incidence of a ray of light impinging on the surface(s) in a given direction of incidence. Furthermore, multilayer reflectors can be used as reflectors. Such multilayer reflectors may be designed having a lower absorption than metallic reflectors.

1. A waveguide (40; 51; 61), arranged to guide light from at least one light source (53a-c), said waveguide comprising:
at least one guiding edge (43; 50a-c; 60) adapted to contain said light in said waveguide (40; 51; 61), and
an extraction edge (44; 50d) adapted to enable extraction of said light from said waveguide (40; 51; 61),
wherein said guiding edge (43; 50a-c; 60) is configured to reflect said light on its way towards said extraction edge (44; 50d), characterized in that:
said guiding edge (43; 50a-c; 60) is further configured such that a direction (xᵣ₁, xᵣ₂) of reflection of a ray of light impinging on said guiding edge (43; 50a-c; 60), in a given direction (xᵢ) of incidence relative to a general direction (x₀) of extension of said guiding edge (43; 50a-c; 60), is dependent on a position (P₁, P₂) of incidence along said guiding edge (43; 50a-c; 60).

2. A waveguide (51) according to claim 1, wherein said at least one guiding edge (50a-c) exhibits a macro-structure along its general direction (x₀) of extension.

3. A waveguide (51) according to claim 2, wherein said macro-structure comprises at least one curved portion (52a-d).

4. A waveguide (51) according to claim 3, wherein said macro-structure comprises a plurality of curved portions (52a-d).

5. A waveguide (51) according to claim 3, wherein at least one of said curved portions (52a-d) spans an angular distance (θ) greater than 1 degree.

6. A waveguide (51) according to claim 5, wherein said angular distance (θ) is greater than 1 degree and smaller than 10 degrees.

7. A waveguide (51) according to claim 2, wherein said macrostructure is essentially saw-tooth shaped, having positive and negative peaks (52+, 52−), and wherein at least one of said peaks (52+, 52−) has an opening angle (η) greater than 160 degrees.

8. A waveguide (61) according to claim 1, wherein said at least one guiding edge (60) is configured to provide diffuse reflection.

9. A waveguide (61) according to claim 8, wherein said guiding edge (60) is configured to provide asymmetrically diffuse reflection.

10. A waveguide (40; 51; 61) according to claim 1, wherein said at least one guiding edge (43; 50a-c; 60) is provided with a sub-wavelength structure capable of modifying said direction of reflection.

11. A waveguide (40; 51; 61) according to claim 1, wherein said waveguide is a planar waveguide.

12. A waveguide (40; 51; 61) according to claim 1, wherein said waveguide is arranged to guide light from a plurality of light sources (53a-c).

13. A lighting device comprising at least one light source (53a-c) and a waveguide (40; 51; 61) according to claim 1.

14. A lighting device according to claim 13, wherein said lighting device comprises a plurality of light sources (53a-c).

15. A lighting device according to claim 13, wherein at least one of said light sources (53a-c) is at least one of side-emitting and lambertian LEDs.

16. A display device comprising a display and a lighting device according to claim 13.
